(19) United States
(12) Patent Application Publication
(10) Pub. No.: US 2026/0340769 A1
(43) Pub. Date: Oct. 29, 2026

(54) DYNAMICALLY-ADAPTIVE GEOMETRIC TRANSFORMATIONS BASED ON EYE POSE AND CAMERA POSE CHANGES FOR VIDEO SEE-THROUGH (VST) EXTENDED REALITY (XR)

(71) Applicant: Samsung Electronics Co., Ltd., Suwon-si (KR)

(72) Inventor: Yingen Xiong, Mountain View, CA (US)

(21) Appl. No.: 19/552,999

(22) Filed: Feb. 27, 2026

Related U.S. Application Data
(60) Provisional application No. 63/796,894, filed on Apr. 29, 2025.

(51) Int. Cl. G06T 3/60; G06T 3/20; G06V 40/18

(52) U.S. Cl. CPC G06T 3/60; G06T 3/20; G06V 40/18

(57) ABSTRACT

A method includes obtaining first image frames of a scene captured using one or more see-through cameras of a video-see through (VST) extended reality (XR) device and obtaining second image frames of eyes of a user of the VST XR device. The method also includes determining positions of pupils of the user's eyes and orientations of the user's eyes based on the second image frames. The method further includes determining geometric transformations based on (i) the positions of the user's pupils and the orientations of the user's eyes and (ii) poses of the see-through cameras. In addition, the method includes performing passthrough transformations of the first image frames based on the geometric transformations to generate transformed image frames and rendering images for display based on the transformed image frames.

### CROSS-REFERENCE TO RELATED APPLICATION AND PRIORITY CLAIM

This application claims priority under 35 U.S.C. § 119 (e) to U.S. Provisional Patent Application No. 63/796,894 filed on Apr. 29, 2025. This provisional patent application is hereby incorporated by reference in its entirety.

### TECHNICAL FIELD

This disclosure relates generally to image processing systems and processes. More specifically, this disclosure relates to dynamically-adaptive geometric transformations based on eye pose and camera pose changes for video see-through (VST) extended reality (XR).

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to dynamically-adaptive geometric transformations based on eye pose and camera pose changes for video see-through (VST) extended reality (XR).

In a first embodiment, a method includes obtaining, using at least one processing device of a VST XR device, first image frames of a scene captured using one or more see-through cameras of the VST XR device. The method also includes obtaining, using the at least one processing device, second image frames of eyes of a user of the VST XR device. The method further includes determining, using the at least one processing device, positions of pupils of the user's eyes and orientations of the user's eyes based on the second image frames. The method also includes determining, using the at least one processing device, geometric transformations based on (i) the positions of the user's pupils and the orientations of the user's eyes and (ii) poses of the see-through cameras. The method further includes performing, using the at least one processing device, passthrough transformations of the first image frames based on the geometric transformations to generate transformed image frames. In addition, the method includes rendering, using the at least one processing device, images for display based on the transformed image frames.

In a second embodiment, a VST XR device includes one or more see-through cameras and at least one processing device. The at least one processing device is configured to obtain first image frames of a scene captured using the one or more see-through cameras and obtain second image frames of eyes of a user of the VST XR device. The at least one processing device is also configured to determine positions of pupils of the user's eyes and orientations of the user's eyes based on the second image frames and determine geometric transformations based on (i) the positions of the user's pupils and the orientations of the user's eyes and (ii) poses of the see-through cameras. The at least one processing device is further configured to perform passthrough transformations of the first image frames based on the geometric transformations to generate transformed image frames and render images for display based on the transformed image frames.

In a third embodiment, a non-transitory machine readable medium contains instructions that when executed cause at least one processor of a VST XR device to obtain first image frames of a scene captured using one or more see-through cameras of the VST XR device and obtain second image frames of eyes of a user of the VST XR device. The non-transitory machine readable medium also contains instructions that when executed cause the at least one processor to determine positions of pupils of the user's eyes and orientations of the user's eyes based on the second image frames and determine geometric transformations based on (i) the positions of the user's pupils and the orientations of the user's eyes and (ii) poses of the see-through cameras. The non-transitory machine readable medium further contains instructions that when executed cause the at least one processor to perform passthrough transformations of the first image frames based on the geometric transformations to generate transformed image frames and render images for display based on the transformed image frames.

Any one or any combination of the following features may be used with the first, second, or third embodiment.

The geometric transformations may be determined by determining first geometric transformation matrices based on the positions of the user's pupils and the orientations of the user's eyes; identifying second geometric transformation matrices based on the poses of the see-through cameras; and combining the first geometric transformation matrices and the second geometric transformation matrices to generate final geometric transformation matrices for the user's eyes.

The first geometric transformation matrices may be determined by determining rotation matrices using the orientations of the user's eyes; determining translation vectors using the positions of the user's pupils; and combining the rotation matrices and the translation vectors to generate the first geometric transformation matrices.

The first geometric transformation matrices may be dynamic and may vary based on movements of the user's eyes. The second geometric transformation matrices may be static and may not vary based on the movements of the user's eyes.

The second image frames may capture the user's eyes as illuminated by light sources of the VST XR device.

The poses of the see-through cameras may be expressed relative to the VST XR device and may be based on extrinsic parameters determined during calibration of the VST XR device.

Display of the rendered images may be initiated on one or more display panels of the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for dynamically-adaptive geometric transformations based on eye pose and camera pose changes for video see-through (VST) extended reality (XR) in accordance with this disclosure;

FIGS. 3A and 3B illustrate a more specific example process for dynamically-adaptive geometric transformations based on eye pose and camera pose changes for VST XR in accordance with this disclosure;

FIGS. 4A through 4E illustrate a portion of an example VST XR headset and reflections caused by different eye poses in accordance with this disclosure;

FIG. 5 illustrates an example of eye orientation and inter-pupillary distance (IPD) tracking in accordance with this disclosure;

FIG. 6 illustrates an example of eye pose-based geometric transformation in accordance with this disclosure;

FIG. 7 illustrates an example of camera pose-based geometric transformation in accordance with this disclosure; and

FIG. 8 illustrates an example method for dynamically-adaptive geometric transformations based on eye pose and camera pose changes for VST XR in accordance with this disclosure.

### DETAILED DESCRIPTION

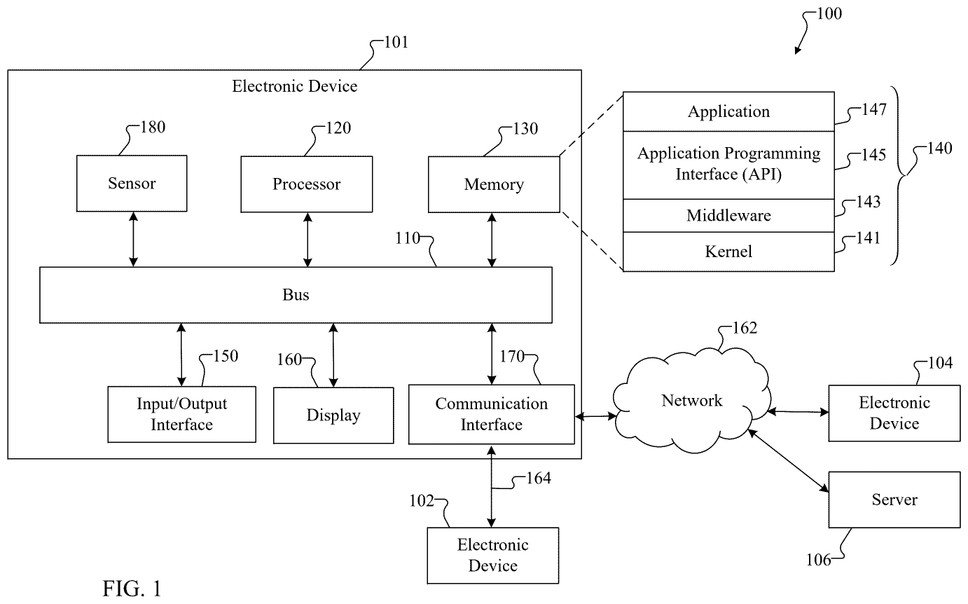

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that imaging sensors are generally positioned at locations spaced apart from a user's eyes and are often pointed in directions at which the user is not looking. As a result, image frames captured using the imaging sensors generally do not match how a scene is being viewed by the user's eyes. Because of this, transformations can be applied to captured image frames in order to make the image frames appear as if they were captured using imaging sensors positioned at the locations of the user's eyes and looking in the same direction(s) as the user's eyes. However, the user generally does not continue looking in the same direction over time and often makes rapid eye movements.

This disclosure provides various techniques supporting dynamically-adaptive geometric transformations based on eye pose and camera pose changes for VST XR. As described in more detail below, first image frames of a scene may be obtained using one or more see-through cameras of a VST XR device, and second image frames of eyes of a user of the VST XR device may be obtained. Positions of pupils of the user's eyes and orientations of the user's eyes may be determined based on the second image frames. Geometric transformations may be determined based on (i) the positions of the user's pupils and the orientations of the user's eyes and (ii) poses of the see-through cameras. Passthrough transformations of the first image frames may be performed based on the geometric transformations to generate transformed image frames, and images may be rendered for display based on the transformed image frames.

In this way, the disclosed techniques can be used to efficiently enable passthrough transformations to be performed in a VST XR pipeline. For example, the disclosed techniques can be used to efficiently create geometric transformations based on the geometric configuration of a VST XR device and the geometric configuration of a user's eyes. The disclosed techniques can also automatically adapt to changes in either geometric configuration. As an example, the position(s) and/or orientation(s) of the see-through camera(s) may change, such as when a user translates and/or rotates the camera(s) on the VST XR device. As other examples, a user may change his or her view or focus during use of the VST XR device, or different users may use the VST XR device. When the geometric configuration of the VST XR device and/or the geometric configuration of the user's eyes changes, the disclosed techniques can automatically adapt the geometric transformations based on the associated eye pose changes and/or camera pose changes. In some cases, these geometric transformations can optionally be integrated with one or more other geometric transformations as needed or desired.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dynamically-adaptive geometric transformations based on eye pose and camera pose changes for VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dynamically-adaptive geometric transformations based on eye pose and camera pose changes for VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dynamically-adaptive geometric transformations based on eye pose and camera pose changes for VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

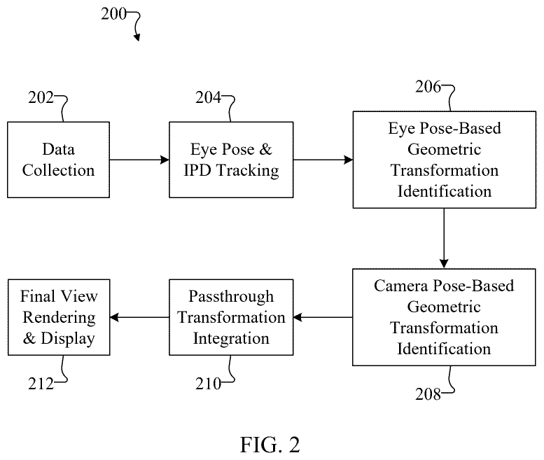

FIG. 2 illustrates an example process 200 for dynamically-adaptive geometric transformations based on eye pose and camera pose changes for VST XR in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes a data collection operation 202, which generally operates to obtain image frames to be processed. For example, the data collection operation 202 could obtain high-resolution color image frames or other image frames captured using one or more see-through color cameras or other imaging sensors 180 of the electronic device 101. The data collection operation 202 can obtain any suitable number of image frames. In some cases, the process 200 may receive image frames at a specified frame rate, such as 30, 60, 90, or 120 frames per second. The image frames may also be obtained from any suitable number of imaging sensors 180, such as from left and right see-through cameras. Further, each image frame can have any suitable size, shape, and resolution and include image data in any suitable domain. As particular examples, each image frame may include RGB image data, YUV image data, or Bayer or other raw image data. In addition, different image frames capturing the same scene could have the same exposure or different exposures.

The data collection operation 202 also generally operates to obtain eye tracking image frames, such as from one or more eye tracking sensors 180. The eye tracking image frames can include image frames capturing the user's left and right eyes. The eye tracking image frames may be obtained using any suitable sensor(s) 180, such as from one or more eye pose tracking cameras. The eye pose tracking cameras can represent high-resolution cameras that capture image frames of the user's eyes during illumination by one or more infrared or other illuminators (like one or more light emitting diodes) of the electronic device 101.

The data collection operation 202 may optionally obtain other information to be processed. For example, the data collection operation 202 could be used to obtain depth data from one or more depth sensors 180 and head poses from one or more positional sensors 180. The depth data may generally represent measurements or estimates of the depths within a scene, meaning distances between the electronic device 101 and various points within the scene being imaged. The depth data may be obtained using any suitable sensor(s) 180, such as one or more time-of-flight (ToF) sensors, light detection and ranging (LiDAR) sensors, or stereo vision sensors. The head pose data may represent measurements or estimates of the pose of a user's head while the electronic device 101 is being used. In some cases, the head pose data may be expressed using six degrees of freedom, such as three translation values identifying movement of the user's head along three orthogonal axes and three rotation values identifying rotation of the user's head about the three orthogonal axes. The head pose data may be obtained using any suitable sensor(s) 180, such as from one or more IMUs.

The information obtained by the data collection operation 202 is provided to and processed by an eye pose and inter-pupillary distance (IPD) tracking operation 204. The eye pose and IPD tracking operation 204 generally operates to identify poses (and therefore pose changes) of the user's eyes over time. An eye pose can include positions of pupils of the user's eyes and/or orientations of the user's eyes. For example, the eye pose and IPD tracking operation 204 can analyze the image frames obtained by the data collection operation 202 from the eye pose tracking cameras to identify the positions of the user's pupils in the image frames and eye gaze vectors of the user's eyes, where the eye gaze vectors identify the direction(s) in which the user's eyes appear to be gazing. In some cases, identified eye poses may be expressed as a gaze direction, a focal point, a focal distance, or a combination thereof. The eye pose and IPD tracking operation 204 may also calculate the IPD of the user of the electronic device 101, where the user's IPD is defined as the distance between the centers of the user's pupils.

The eye pose and IPD tracking operation 204 can use any suitable technique(s) to identify eye poses over time. For example, in some embodiments, light sources or other illuminators of the electronic device 101 can emit infrared or other light toward the user's eyes, and the eye pose tracking cameras can capture image frames of pupil reflections and corneal reflections from the user's eyes. The eye pose and IPD tracking operation 204 can analyze the image frames of the user's eyes and estimate the direction(s) and depth(s) of the user's eye gaze to determine the user's eye focus and eye gaze vectors.

An eye pose-based geometric transformation identification operation 206 generally operates to determine geometric transformations to be used to transform captured see-through or other image frames based on changes to the user's eye poses over time. More specifically, these geometric transformations can help to account for changes in the positions of the user's pupils and changes in the orientations of the user's eyes over time. For example, as the user changes his or her focus (such as from near distance to far distance or vice versa), the user may rotate his or her eyes inward or outward. This changes the positions of the user's pupils (and therefore the IPD of the user) over time. This also changes the orientations of the user's eyes as defined by the eye gaze vectors. Similarly, different users may use the electronic device 101, and the different users may have different IPDs and/or different orientation changes over time. The eye pose-based geometric transformation identification operation 206 therefore operates to determine geometric transformations that can account for these changes to the IPD and eye gaze vectors of the user(s). In some cases, a geometric transformation can be determined for a user's left eye, and a geometric transformation can be determined for the user's right eye. Examples of how these geometric transformations can be determined are provided below.

A camera pose-based geometric transformation identification operation 208 generally operates to determine geometric transformations to be used to transform captured see-through or other image frames based on changes to camera poses of the electronic device 101 over time. More specifically, these geometric transformations can help to account for changes in the position(s) and/or orientation(s) of one or more see-through cameras or other imaging sensors 180. For example, the position(s) and/or orientation(s) of the imaging sensor(s) 180 may be mechanically altered, such as by translating an imaging sensor 180 along one of multiple axes (like three orthogonal axes) and/or rotating the imaging sensor 180 about one of the multiple axes. The camera pose-based geometric transformation identification operation 208 therefore operates to determine geometric transformations that can account for these changes to the camera poses. In some cases, a geometric transformation can be determined for the user's left eye, and a geometric transformation can be determined for the user's right eye. Examples of how these geometric transformations can be determined are provided below. In some cases, one or more extrinsic parameters of each imaging sensor 180, which could be determined during calibration of the electronic device 101, may be used by the camera pose-based geometric transformation identification operation 208.

A passthrough transformation integration operation 210 generally operates to combine various transformations to be applied to the image frames captured using the see-through camera(s) or other imaging sensor(s) 180. For example, the passthrough transformation integration operation 210 could combine the geometric transformations identified by the geometric transformation identification operations 206 and 208 with one or more additional transformations. In some embodiments, the passthrough transformation integration operation 210 may identify at least one static passthrough transformation and at least one dynamic passthrough transformation to be combined with the geometric transformations identified by the geometric transformation identification operations 206 and 208. A static transformation may not depend on the contents of the image frames being processed or on the user's eye poses and could be based on the components of the electronic device 101 and/or the configuration of the components of the electronic device 101. A dynamic transformation can vary based on the contents of the image frames being processed or changes to the user's eye poses. Thus, for example, the geometric transformations associated with camera poses could represent static transformations since the camera poses may generally remain consistent during use of the electronic device 101. The geometric transformations associated with the user's eye poses could represent dynamic transformations since the user's eye poses generally change during use of the electronic device 101. In some cases, the static transformations may be determined once or several times during use but not necessarily for each image frame being transformed, while the dynamic transformations may be determined repeatedly (possibly on a per-frame basis).

In some embodiments, the static transformations can include a camera undistortion transformation and/or a display geometric distortion calibration (GDC)/chromatic aberration correction (CAC) transformation. A camera undistortion transformation can be used to correct for lens distortions in captured image frames caused by one or more lenses of one or more imaging sensors 180 used to capture the image frames. A display GDC/CAC transformation can be used to pre-compensate image frames for expected geometric distortions and chromatic aberrations created when rendered images are displayed and viewed through display lenses of the electronic device 101. Also, in some cases, the dynamic transformations can include a time warp reprojection, a planar reprojection, or a depth-based reprojection. A time warp reprojection generally refers to a reprojection of image data from one image frame to another, where the image data is generally within a common plane in both image frames. A planar reprojection generally refers to a reprojection of image data onto a single plane, such as when all background image content is reprojected to a single plane at a single specified depth from the electronic device 101. A depth-based reprojection generally refers to a reprojection of image data based on depths associated with the image data. In general, time warp reprojection is typically less computationally expensive than planar reprojection, and planar reprojection is typically less computationally expensive than depth-based reprojection. The specific type of reprojection being used could be based on, among other things, whether the user's head pose has changed significantly in between image frame captures and/or where the user's eyes are focused within a scene. Each transformation may be implemented in any suitable manner, such as by warping or otherwise modifying one or more image frames to achieve the desired correction(s).

In other embodiments, simplifications of certain geometric transformations could be made, such as to support reduced computational complexity. For example, eye boxes or other defined regions may be identified within the image frames capturing the user's eyes, and at least parts of the user's eyes (such as the user's pupils) could be identified within the predefined regions. Predefined positions of the user's pupils within the defined regions could be used to identify a predefined IPD of the user. Also or alternatively, predefined orientations of the user's eyes (represented using predefined eye gaze vectors) could be identified. The predefined IPD and/or the predefined eye gaze vectors could be used to generate the eye pose-based geometric transformations, which could make these geometric transformations static rather than dynamic for at least part of the time. Thus, if IPD or other eye pose changes are smaller, the same geometric transformations may be reused. If the IPD or other eye pose changes are larger, the eye pose-based geometric transformations may be redetermined as described above.

A final view rendering and display operation 212 generally operates to generate and render final images for display and to initiate display of the rendered images. For example, the final view rendering and display operation 212 may generate transformed image frames by applying integrated transformations as generated by the passthrough transformation integration operation 210 to the image frames capturing using the imaging sensor(s) 180. As a particular example, the final view rendering and display operation 212 could apply an integrated transformation to image frames captured using a left imaging sensor 180 and apply another integrated transformation to image frames captured using a right imaging sensor 180.

The final view rendering and display operation 212 can also perform any additional refinements or modifications needed or desired, where the resulting images can represent the final views of the scene. As a particular example, a 3D-to-2D warping function could be used to warp the final views of the scene into 2D images. The final view rendering and display operation 212 can present the 2D images to a user, such as by rendering the 2D images into a form suitable for transmission to at least one display 160. Note that the at least one display 160 could include (i) a single display in which different rendered images are presented on different portions of one display panel or (ii) multiple displays in which different rendered images are presented on different display panels.

The process 200 shown in FIG. 2 can have various technical benefits or advantages depending on the implementation. For example, the process 200 can be used to efficiently create geometric transformations based on changes in the positions of the user's pupils and the orientations of the user's eyes over time. This can be done dynamically or adaptively by tracking these changes over time, allowing more accurate geometric transformations to be identified and used to generate rendered images viewed by the user. Overall, these features can help to significantly improve the efficiency of a VST XR pipeline implemented using the process 200 and the image quality of the images presented by the VST XR pipeline.

Although FIG. 2 illustrates one example of a process 200 for dynamically-adaptive geometric transformations based on eye pose and camera pose changes for VST XR, various changes may be made to FIG. 2. For example, various operations or functions in FIG. 2 may be combined, further subdivided, replicated, omitted, or rearranged and additional operations or functions may be added according to particular needs.

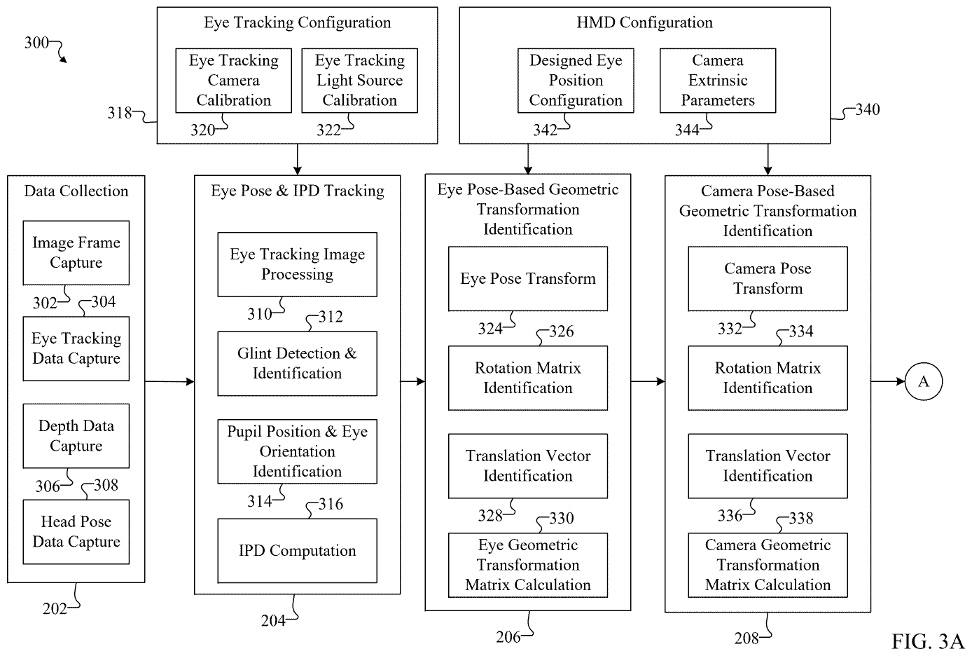

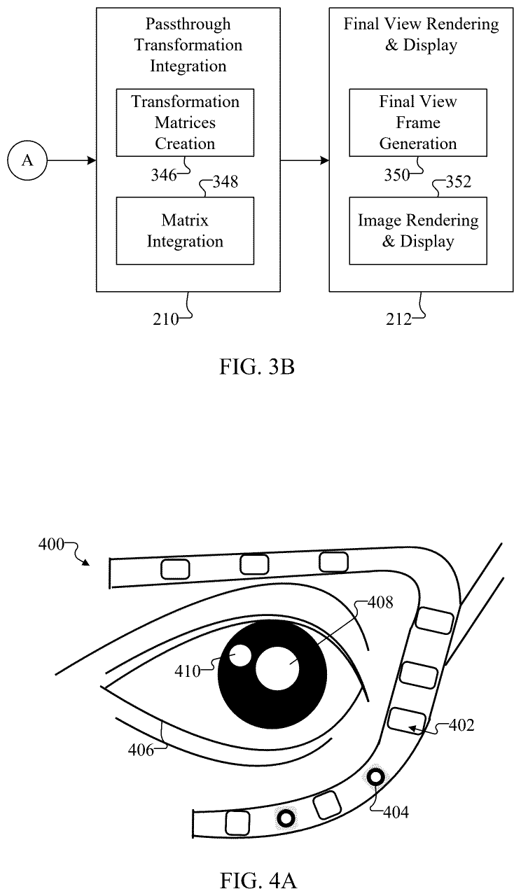

FIGS. 3A and 3B illustrate a more specific example process 300 for dynamically-adaptive geometric transformations based on eye pose and camera pose changes for VST XR in accordance with this disclosure. The process 300 here can represent a more specific implementation of the process 200 shown in FIG. 2. For ease of explanation, the process 300 shown in FIGS. 3A and 3B is described as being performed using the electronic device 101 in the network configuration 100 shown in FIG. 1. However, the process 300 shown in FIGS. 3A and 3B may be performed using any other suitable device(s) and in any other suitable system(s).

As shown in FIG. 3A, the data collection operation 202 may be implemented using an image frame capture function 302, an eye tracking data capture function 304, a depth data capture function 306, and a head pose data capture function 308. The image frame capture function 302 generally operates to obtain image frames of scenes, such as image frames captured using one or more see-through cameras or other imaging sensors 180 of the electronic device 101. In some cases, each captured image frame may represent an image frame of a scene captured by a forward-facing or other imaging sensor(s) 180 of the electronic device 101.

The eye tracking data capture function 304 generally operates to obtain image frames of a user's eyes, such as image frames captured using one or more eye tracking cameras or other sensors 180 of the electronic device 101. As a particular example, these image frames may be obtained using inward-facing cameras, infrared illuminators, lenses, and optics. In some cases, image frames of the user's eyes may be acquired continuously at a high frame rate (such as 60-120 Hz) to track rapid movements, and infrared light can be used to enhance contrast between the pupil, iris, and glints of each of the user's eyes. During rapid eye movements, the user's pupil positions, corneal reflections, and iris outlines can be tracked.

The depth data capture function 306 generally operates to obtain depth data associated with each image frame. The depth data may be obtained from any suitable source(s), such as from one or more depth sensors like at least one ToF sensor, LiDAR, or stereo vision sensor. In some cases, for example, the depth data may include time measurements of light pulses returning to a ToF sensor, distorted light patterns, or RGB images from slightly different angles.

The head pose data capture function 308 generally operates to obtain information related to the pose of the user's head while the electronic device 101 is being used. The head pose information may be obtained from any suitable source(s), such as from one or more positional sensors like at least one IMU. In some cases, the head pose information may be expressed using six degrees of freedom, such as three translation values and three rotation values. The three translation values may identify movement of the user's head along three orthogonal axes, and the three rotation values may identify rotation of the user's head about the three orthogonal axes. Note, however, that the head pose information may have any other suitable form.

In this example, the eye pose and IPD tracking operation 204 may be implemented using an eye tracking image processing function 310, a glint detection and identification function 312, a pupil position and eye orientation identification function 314, and an IPD computation function 316. The eye pose and IPD tracking operation 204 can operate using various eye tracking configuration information 318, such as eye tracking camera calibration data 320 and eye tracking light source calibration data 322.

The eye tracking image processing function 310 generally operates to process the image frames capturing the left and right eyes of the user. For example, the eye tracking image processing function 310 could pre-process the image frames from the eye tracking data capture function 304 in order to perform any desired pre-processing (such as registration or denoising) and to identify areas of the image frames where the user's eyes are located. In other words, the eye tracking image processing function 310 can make an initial determination as to the locations of the user's eyes within the image frames being processed.

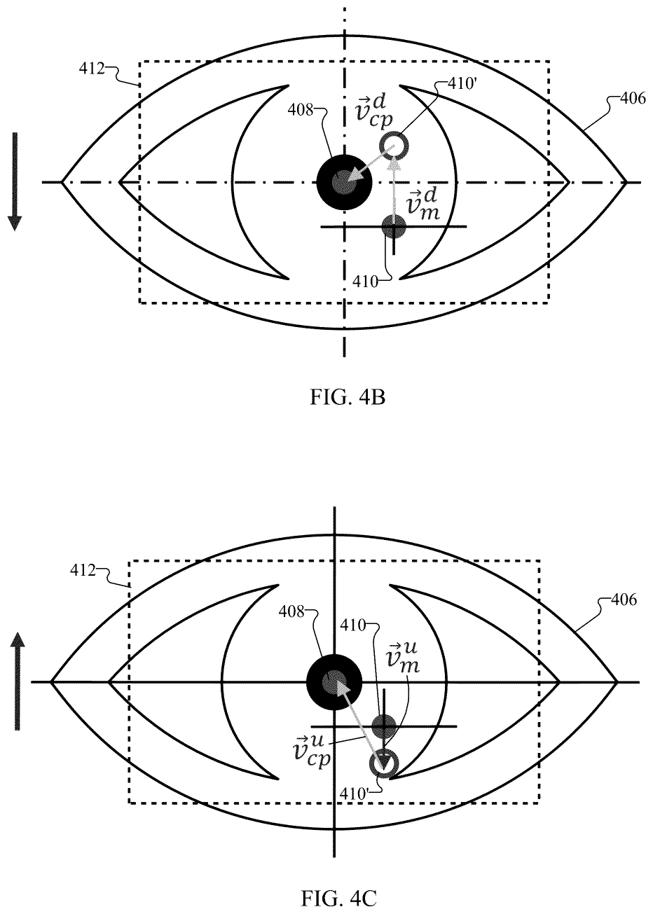

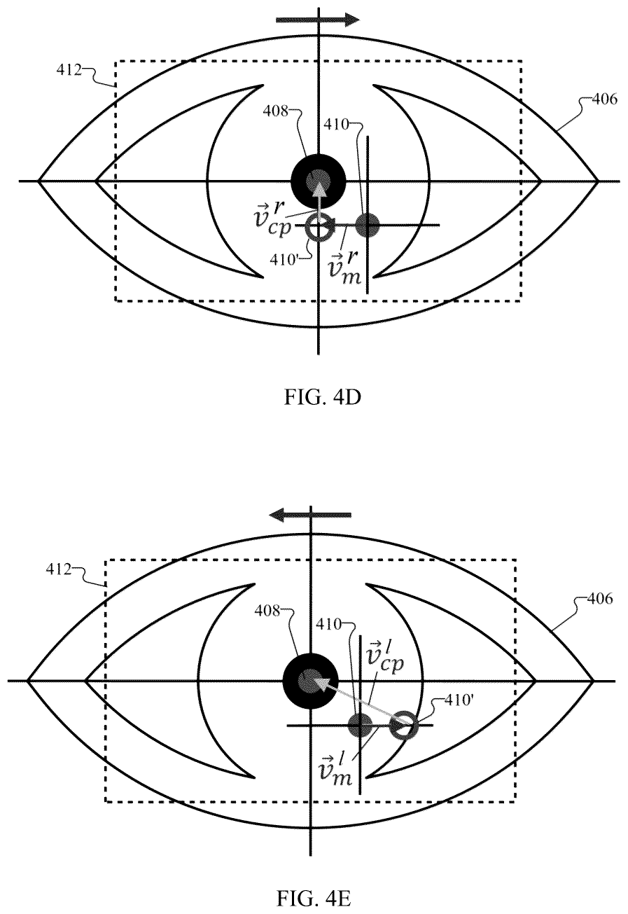

The glint detection and identification function 312 generally operates to process these image frames and identify reflections or “glints” from different portions of the user's eyes. For example, the glint detection and identification function 312 can process the image frames and identify brighter regions of the image frames, which can represent areas where the reflections occur. The pupil position and eye orientation identification function 314 generally operates to use the positions of the detected reflections to identify positions of the user's pupils and the orientations of the user's eyes. For instance, changes in the viewing directions of the user's eyes can result in changes in the locations of the identified reflections, allowing the pupil position and eye orientation identification function 314 to estimate how the positions of the user's pupils and the orientations of the user's eyes change over time. One example of this is explained below with reference to FIGS. 4A through 4E.

The IPD computation function 316 generally operates to determine the current IPD of the user based on the current positions of the user's pupils as determined by the pupil position and eye orientation identification function 314. Since the user's IPD is defined as the distance between the centers of the user's pupils, the IPD computation function 316 can calculate the distance between the estimated locations of the centers of the user's pupils to calculate the user's current IPD. As noted earlier, the user's IPD can change based on focus changes, where the user rotates his or her eyes inward or outward depending on the user's depth of focus.

The eye tracking camera calibration data 320 generally relates to calibration data associated with the eye tracking cameras used to capture the image frames of the user's eyes, and the light source calibration 222 generally relates to calibration data associated with the illuminators or other light sources that illuminate the user's eyes while the image frames are captured using the eye tracking cameras. For example, the eye tracking camera calibration data 320 may define one or more characteristics of each eye tracking camera, such as its position and orientation relative to a predefined location (like an expected center of the location of a user's eye). The light source calibration 222 may define one or more characteristics of each light source, such as its position and orientation relative to the predefined location. This information can be useful in identifying the positions of the user's pupils and the orientations of the user's eyes based on reflections from the user's eyes.

In this example, the eye pose-based geometric transformation identification operation 206 may be implemented using an eye pose transformation function 324, a rotation matrix identification function 326, a translation vector identification function 328, and an eye geometric transformation matrix calculation function 330. Similarly, the camera pose-based geometric transformation identification operation 208 may be implemented using a camera pose transformation function 332, a rotation matrix identification function 334, a translation vector identification function 336, and a camera geometric transformation matrix calculation function 338. The geometric transformation identification operations 206 and 208 can operate using various HMD configuration information 340, such as designed eye position configuration information 342 and camera extrinsic parameters 344.

The eye pose transformation function 324 generally operates to transform eye poses of the user's eyes to a coordinate system associated with the electronic device 101. For example, the eye pose transformation function 324 may transform the positions of the centers of the user's pupils into coordinates within the electronic device's coordinate system. The eye pose transformation function 324 may also transform eye gaze vectors associated with the user's eyes into vectors defined using coordinates within the electronic device's coordinate system. These transformations can typically be derived mathematically based on relationships between the coordinate systems associated with the user's eyes and the electronic device's coordinate system.

The rotation matrix identification function 326 generally operates to compute, for each of the user's eyes, a rotation matrix based on the identified orientation of that eye. The translation vector identification function 328 generally operates to compute, for each of the user's eyes, a translation vector based on the current position of the pupil of that eye. For example, each rotation matrix can define how the associated eye of the user is rotated within the electronic device's coordinate system. Similarly, each translation vector can define the position of the associated pupil within the electronic device's coordinate system. Example approaches for determining rotation matrices and translation vectors are provided below.

The eye geometric transformation matrix calculation function 330 generally operates to calculate a geometric transformation matrix for each eye of the user based on the rotation matrix and the translation vector for that eye. In some cases, the geometric transformation matrix for each eye of the user can represent a combination of the rotation matrix and the translation vector associated with that eye.

The camera pose-based geometric transformation identification operation 208 generally operates to transform one or more camera poses of the imaging sensor(s) 180 to the coordinate system associated with the electronic device 101. For example, the camera pose-based geometric transformation identification operation 208 may transform the position of each imaging sensor 180 into coordinates within the electronic device's coordinate system. The camera pose-based geometric transformation identification operation 208 may also transform the direction in which each imaging sensor 180 is pointed into a vector defined using coordinates within the electronic device's coordinate system. These transformations can typically be derived mathematically based on relationships between each camera's position and/or orientation and the electronic device's coordinate system.

The rotation matrix identification function 334 and the translation vector identification function 336 generally operate to compute, for each imaging sensor 180, a rotation matrix and a translation vector for that imaging sensor 180. For example, each rotation matrix can define how the associated imaging sensor 180 is rotated within the electronic device's coordinate system. Each translation vector can define the position of the associated imaging sensor 180 within the electronic device's coordinate system. Example approaches for determining rotation matrices and translation vectors are provided below.

The camera geometric transformation matrix calculation function 338 generally operates to calculate a geometric transformation matrix for each imaging sensor 180 based on the rotation matrix and the translation vector for that imaging sensor 180. In some cases, the geometric transformation matrix for each imaging sensor 180 can represent a combination of the rotation matrix and the translation vector associated with that imaging sensor 180.

The designed eye position configuration information 342 generally relates to configuration data associated with where images would be focused on the user's eyes given predefined locations and orientations of the user's eyes. This is typically based on the assumed geometry of the electronic device 101 and the assumed poses of the user's eyes. Differences between the actual and assumed geometries of the electronic device 101 and between the actual and assumed eye poses can be used by the eye geometric transformation matrix calculation function 330. For instance, the eye geometric transformation matrix calculation function 330 can generate geometric transformation matrices that correct for the differences between the assumed device geometry and eye poses and the actual device geometry and eye poses.

The camera extrinsic parameters 344 generally relate to one or more extrinsic parameters of each imaging sensor 180 used to capture the image frames obtained by the image frame capture function 302, such as the location and orientation of each imaging sensor 180. The camera geometric transformation matrix calculation function 338 can use the extrinsic parameter(s) of the imaging sensor(s) 180 to generate geometric transformation matrices that account for the differences in the locations/orientations of the user's eyes and the locations/orientations of the imaging sensor(s) 180.

As shown in FIG. 3B, the passthrough transformation integration operation 210 may be implemented using a transformation matrices creation function 346 and a matrix integration function 348. The transformation matrices creation function 346 generally operates to create passthrough transformation matrices, such as static and dynamic passthrough transformation matrices, to be applied to the image frames obtained using the image frame capture function 302. For example, the transformation matrices creation function 346 may identify a camera undistortion transformation matrix, a GDC/CAC transformation matrix, and/or a time warp reprojection, planar reprojection, or depth-based reprojection matrix.

The matrix integration function 348 generally operates to combine the transformation matrices generated by the transformation matrices creation function 346 with the geometric transformation matrices generated by the geometric transformation matrix calculation functions 330 and 338. For example, the matrix integration function 348 can integrate certain transformation matrices generated by the transformation matrices creation function 346 and certain geometric transformation matrices generated by the geometric transformation matrix calculation functions 330 and 338 for the left eye of the user. The matrix integration function 348 can also integrate other transformation matrices generated by the transformation matrices creation function 346 and other geometric transformation matrices generated by the geometric transformation matrix calculation functions 330 and 338 for the right eye of the user. In some cases, the integration of various matrices could be accomplished using matrix multiplications. These functions 346 and 348 effectively help to combine multiple transformations into a single matrix so that an image frame can be transformed once to implement all of the various transformations, helping to improve efficiency and reduce latency of the overall pipeline.

The final view rendering and display operation 212 may be implemented using a final view frame generation function 350 and an image rendering and display function 352. The final view frame generation function 350 generally operates to apply the integrated transformation matrices generated by the passthrough transformation integration operation 210 to the image frames obtained by the image frame capture function 302. For example, the final view frame generation function 350 can apply integrated transformation matrices associated with the user's left eye to image frames captured using a left imaging sensor 180 and apply integrated transformation matrices associated with the user's left eye to image frames captured using a right imaging sensor 180. The image rendering and display function 352 generally operates to render images for display and to initiate presentation of the rendered images. For instance, the image rendering and display function 352 can perform 3D-to-2D warping or other functions to generate 2D images that are displayed.

Although FIGS. 3A and 3B illustrate one more specific example of a process 300 dynamically-adaptive geometric transformations based on eye pose and camera pose changes for VST XR, various changes may be made to FIGS. 3A and 3B. For example, various operations or functions in FIGS. 3A and 3B may be combined, further subdivided, replicated, omitted, or rearranged and additional operations or functions may be added according to particular needs.

FIGS. 4A through 4E illustrate a portion of an example VST XR headset 400 and reflections caused by different eye poses in accordance with this disclosure. The VST XR headset 400 may, for example, represent a specific implementation of the electronic device 101 in the network configuration 100 of FIG. 1. However, the VST XR headset 400 may be used in any other suitable system(s) and may be implemented in any other suitable manner. Also, while the VST XR headset 400 in this example takes the form of smart glasses, the VST XR headset 400 may have any other suitable form factor.

As shown in FIG. 4A, the VST XR headset 400 includes one or more illumination sources 402 and one or more eye-tracking imaging sensors 404. Each illumination source 402 is configured to generate illumination that can be directed at a user's eye 406. Each illumination source 402 can generate any suitable illumination, such as infrared illumination. Note that the number and positions of the illumination sources 402 shown in FIG. 4A are for illustration only. The VST XR headset 400 may include any suitable number of illumination sources 402, and the illumination source(s) 402 may be positioned at any suitable location(s). Each illumination source 402 represents any suitable structure configured to generate illumination for a user's eye 406, such as an infrared or other light emitting diode (LED).

Each eye-tracking imaging sensor 404 is configured to capture one or more images of the user's eye 406. The illumination from the illumination source(s) 402 can reflect from the user's eye 406, and these reflections can be captured in the images obtained using the eye-tracking imaging sensor(s) 404. In some cases, for instance, the illumination from the illumination source(s) 402 can create a reflection 408 from the pupil of the user's eye 406 and one or more reflections 410 from the cornea of the user's eye 406. Each eye-tracking imaging sensor 404 can capture images of the user's eye 406 that include at least some of these reflections 408, 410. The locations of these reflections 408, 410 can be used by the VST XR headset 400 to identify the position of the user's pupil and/or the orientation of the user's eye 406. Each eye-tracking imaging sensor 404 includes any suitable structure configured to capture images of a user's eye 406, such as an infrared or other camera.

Note that eye-tracking technology often attempts to identify the deformation of reflections off a user's eye in order to measure eye movements. Here, the positions of illumination reflections can be used to sense movement of the user's eye 406 relative to the VST XR headset 400. Different eye poses of the user's eyes can create different displacements or pose changes of the user's eye 406 relative to the VST XR headset 400, and these different pose changes can be identified and used to estimate the locations of the user's pupils and the orientations of the user's eyes. FIGS. 4B through 4E illustrate examples of how different eye poses can be identified.

In the following discussion, two motion vectors are defined for each movement of the user's eye 406 relative to the VST XR headset 400. One motion vector

$$( denoted {\vec{v}}_{m}^{x} )$$

represents motion of a reflection 410 from the user's cornea, meaning this motion vector identifies a change in the location of a reflection 410 from the user's cornea between different image frames captured at different times. Another motion vector

$$( denoted {\vec{v}}_{c p}^{x} )$$

represents motion between the reflection 410 from the user's cornea and a reflection 408 from the user's pupil, meaning this motion vector identifies the difference in positions of the two reflections 408, 410. The value x in the above notations can be replaced with u for upward movement of the user's eye 406, d for downward movement of the user's eye 406, r for rightward movement of the user's eye 406, and/for leftward movement of the user's eye 406. Also shown in FIGS. 4B through 4E is an eye box 412, which represents a portion of the user's eye 406 that might be imaged using at least one eye-tracking imaging sensor 404.

As shown in FIG. 4B, the user has moved the user's eye 406 downward relative to the VST XR device 400. Here, a reflection 410 represents a reflection from the user's cornea prior to this movement, and a reflection 410′ represents a reflection from the user's cornea after this movement. The differences in the locations of the reflections 410 and 410′ form a motion vector

$${\vec{v}}_{m}^{d} .$$

Also, the differences in the locations of the reflections 410′ and 408 form a motion vector

$${\vec{v}}_{c p}^{d} .$$

The VST XR headset 400 can use the upward direction of the motion vector

$${\vec{v}}_{m}^{d}$$

and the inward and downward direction of the motion vector

$${\vec{v}}_{c p}^{d}$$

to identify that the user's eye 406 has moved downward relative to the VST XR headset 400. The VST XR headset 400 can also use the magnitude(s) of one or both motion vectors to identify the magnitude of the downward movement of the user's eye 406 relative to the VST XR headset 400.

As shown in FIG. 4C, the user has moved the user's eye 406 upward relative to the VST XR device 400. Here, a reflection 410 represents a reflection from the user's cornea prior to this movement, and a reflection 410′ represents a reflection from the user's cornea after this movement. The differences in the locations of the reflections 410 and 410′ form a motion vector

$${\vec{v}}_{m}^{u} .$$

Also, the differences in the locations of the reflections 410′ and 408 form a motion vector

$${\vec{v}}_{c p}^{u} .$$

The VST XR headset 400 can use the downward direction of the motion vector

$${\vec{v}}_{m}^{u}$$

and the inward and upward direction of the motion vector

$${\vec{v}}_{c p}^{u}$$

to identify that the user's eye 406 has moved upward relative to the VST XR headset 400. The VST XR headset 400 can also use the magnitude(s) of one or both motion vectors to identify the magnitude of the upward movement of the user's eye 406 relative to the VST XR headset 400.

As shown in FIG. 4D, the user has moved the user's eye 406 rightward relative to the VST XR device 400. Here, a reflection 410 represents a reflection from the user's cornea prior to this movement, and a reflection 410′ represents a reflection from the user's cornea after this movement. The differences in the locations of the reflections 410 and 410′ form a motion vector

$${\vec{v}}_{m}^{r} .$$

Also, the differences in the locations of the reflections 410′ and 408 form a motion vector

$${\vec{v}}_{c p}^{r} .$$

The VST XR headset 400 can use the leftward direction of the motion vector

$${\vec{v}}_{m}^{r}$$

and the inward and upward direction of the motion vector

$${\vec{v}}_{c p}^{r}$$

to identify that the user's eye 406 has moved rightward relative to the VST XR headset 400. The VST XR headset 400 can also use the magnitude(s) of one or both motion vectors to identify the magnitude of the rightward movement of the user's eye 406 relative to the VST XR headset 400.

As shown in FIG. 4E, the user has moved the user's eye 406 leftward relative to the VST XR device 400. Here, a reflection 410 represents a reflection from the user's cornea prior to this movement, and a reflection 410′ represents a reflection from the user's cornea after this movement. The differences in the locations of the reflections 410 and 410′ form a motion vector

$${\vec{v}}_{m}^{l} .$$

Also, the differences in the locations of the reflections 410′ and 408 form a motion vector

$${\vec{v}}_{c p}^{l} .$$

The VST XR headset 400 can use the rightward direction of the motion vector

$${\vec{v}}_{m}^{l}$$

and the inward and upward direction of the motion vector

$${\vec{v}}_{c p}^{l}$$

to identify that the user's eye 406 has moved leftward relative to the VST XR headset 400. The VST XR headset 400 can also use the magnitude(s) of one or both motion vectors to identify the magnitude of the leftward movement of the user's eye 406 relative to the VST XR headset 400.

In the above description, the terms “inward” and “outward” are used to refer to directions relative to the pupil of the user's eye 406. That is, “inward” refers to a motion vector that points towards the pupil of the user's eye or otherwise towards a vertical axis on which the pupil of the user's eye lies. Conversely, “outward” refers to a motion vector that points away from the pupil of the user's eye or otherwise away from the vertical axis on which the pupil of the user's eye lies. This notation is used since various reflections 410, 410′ may occur on either side of the user's pupil, such as depending on whether it is the user's left or right eye 406 being illuminated and imaged.

Although FIGS. 4A through 4E illustrate a portion of one example of a VST XR headset 400 and reflections caused by different eye poses, various changes may be made to FIGS. 4A through 4E. For example, the VST XR headset 400 may have any other suitable form factor. Also, the arrangement shown in FIG. 4A can be duplicated on the opposite side of the XR headset 400, meaning each eye 406 of the user may be illuminated using one or more illumination sources 402 and imaged using one or more eye-tracking imaging sensors 404. In addition, the specific movements of the user's eye shown in FIGS. 4B through 4E are examples only and can vary as needed or desired. For instance, the user could look both upward and rightward, upward and leftward, downward and rightward, or downward and leftward.

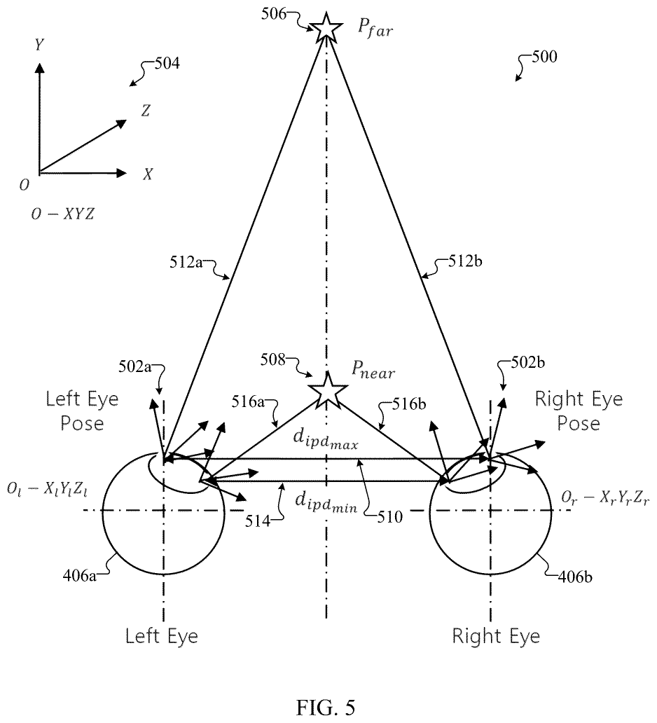

FIG. 5 illustrates an example of eye orientation and IPD tracking 500 in accordance with this disclosure. The eye orientation and IPD tracking 500 may, for example, provide a basis for how the eye pose and IPD tracking operation 204 can be performed. For ease of explanation, the eye orientation and IPD tracking 500 shown in FIG. 5 is described as being performed using the electronic device 101 in the network configuration 100 shown in FIG. 1, which could have the form shown in FIG. 4A. However, the eye orientation and IPD tracking 500 shown in FIG. 5 may be performed using any other suitable device(s) and in any other suitable system(s).

As shown in FIG. 5, a left eye 406a and a right eye 406b of a user are illustrated. The user's left eye 406a is associated with a coordinate system 502a, which is defined using an origin Oₗ and coordinates along three axes Xₗ, Yₗ, and Zₗ. The user's right eye 406b is associated with a coordinate system 502b, which is defined using an origin Or and coordinates along three axes Xᵣ, Yᵣ, and Zᵣ. A global coordinate system 504 is defined using an origin O and coordinates along three axes X, Y, and Z. Since the user's eyes 406a-406b can rotate, the coordinate systems 502a-502b could rotate with the user's eyes 406a-406b, while the global coordinate system 504 here can remain fixed.

The user here is shown as gazing at two different points within the scene, namely a far point 506 and a near point 508. When gazing at the far point 506, the user's eyes 406a-406b are rotated more outward, creating an IPD 510 (denoted d_{ipd}_{ₘₐₓ}) between the centers of the user's pupils. Two gaze vectors 512a-512b can define the orientations of the user's eyes 406a-406b while gazing at the far point 506. When gazing at the near point 508, the user's eyes 406a-406b are rotated more inward, creating an IPD 514 (denoted d_{ipd}_{ₘᵢₙ}) between the centers of the user's pupils. Two gaze vectors 516a-516b can define the orientations of the user's eyes 406a-406b while gazing at the near point 508.

Using this as a basis, in some embodiments, the eye pose and IPD tracking operation 204 may determine the user's current IPD, such as in the following manner.

d_{ipd}=\sqrt{(xₑₗ−xₑᵣ)²+(yₑₗ−yₑᵣ)²+(zₑₗ−zₑᵣ)²}

Here, xₑₗ, xₑᵣ, yₑₗ, yₑᵣ, zₑₗ, and zₑᵣ represent coordinates of the centers of the user's eyes 406a-406b at a given instant. A range of the user's IPD when viewing locations between the far point 506 and the near point 508 could be defined based [d_{ipd}_{ₘᵢₙ}, d_{ipd}_{ₘₐₓ}] and could be expressed as follows.

$${d}_{{ipd}_{min}} = \sqrt{{( {x}_{{el}_{ner}} - {x}_{{er}_{near}} )}^{2} + {( {y}_{{el}_{ner}} - {y}_{{er}_{near}} )}^{2} + {( {z}_{{el}_{ner}} - {z}_{{er}_{near}} )}^{2}}$$

$${d}_{{ipd}_{max}} = \sqrt{{( {x}_{{el}_{far}} - {x}_{{er}_{far}} )}^{2} + {( {y}_{{el}_{far}} - {y}_{{er}_{far}} )}^{2} + {( {z}_{{el}_{far}} - {z}_{{er}_{far}} )}^{2}}$$

Here, (xₑₗ_{ₙₑₐᵣ},yₑₗ_{ₙₑₐᵣ},zₑₗ_{ₙₑₐᵣ}) represent the coordinates of the user's left eye 406a while looking at the near point 508, and (xₑᵣ_{ₙₑₐᵣ},yₑᵣ_{ₙₑₐᵣ},zₑᵣ_{ₙₑₐᵣ}) represent the coordinates of the user's right eye 406b while looking at the near point 508. Similarly, (xₑₗ_{_{far}},yₑₗ_{_{far}},xₑₗ_{_{far}}) represent the coordinates of the user's left eye 406a while looking at the far point 506, and (xₑᵣ_{_{far}},yₑᵣ_{_{far}},zₑᵣ_{_{far}}) represent the coordinates of the user's right eye 406b while looking at the far point 506.

By performing eye tracking and IPD identification, it is possible to identify the centers of the user's pupils and the orientations of the user's eyes 406a-406b, which could be expressed as follows.

$$Pupil Centers = \{ \begin{matrix}( {x}_{el} , {y}_{el} , {z}_{el} ) \\ ( {x}_{er} , {y}_{er} , {z}_{er} )\end{matrix}$$

$$Eye Orientations = \{ \begin{matrix}( {φ}_{elx} , {φ}_{ely} , {φ}_{elz} ) \\ ( {φ}_{erx} , {φ}_{ery} , {φ}_{erz} )\end{matrix}$$

Pupil positions and eye orientations can change while the user's eyes 406a-406b move to provide different focuses and gaze directions, and the pupil positions and eye orientations can be used when generating final view frames in order to fit to the user's eyes adaptively.

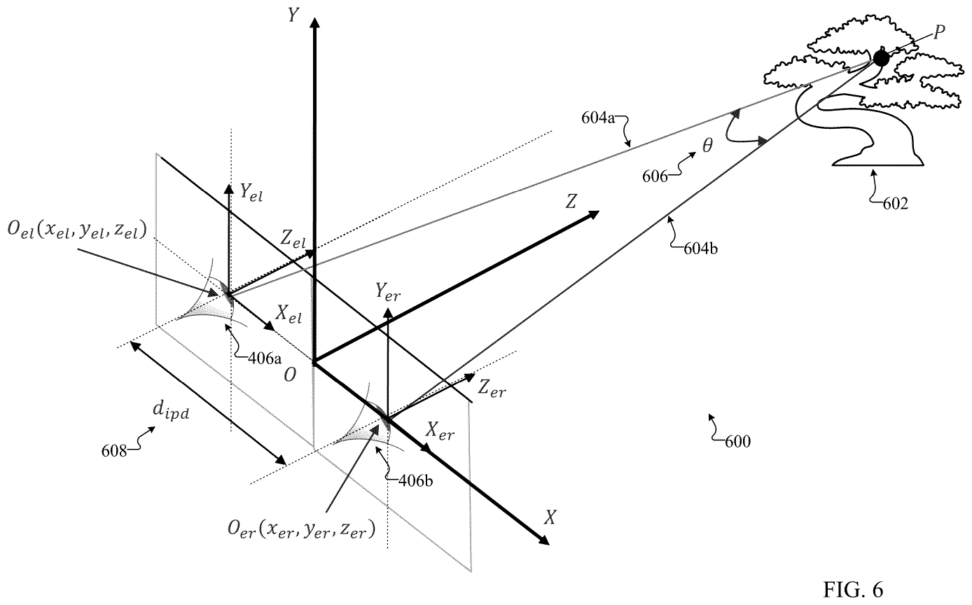

FIG. 6 illustrates an example of eye pose-based geometric transformation 600 in accordance with this disclosure. The eye pose-based geometric transformation 600 may, for example, provide a basis for how the eye pose-based geometric transformation identification operation 206 can be performed. For ease of explanation, the eye pose-based geometric transformation 600 shown in FIG. 6 is described as being performed using the electronic device 101 in the network configuration 100 shown in FIG. 1, which could have the form shown in FIG. 4A. However, the eye pose-based geometric transformation 600 shown in FIG. 6 may be performed using any other suitable device(s) and in any other suitable system(s).

As shown in FIG. 6, the user's eyes 406a-406b are focusing on a point P of an object 602 in a scene. This eye pose of the user is associated with eye gaze vectors 604a-604b, which have an angle θ 606 between them and intersect at the point P of the object 602. The user's eyes 406a-406b have an IPD 608, which is based on the current locations of the centers of user's pupils.

Using this as a basis, in some embodiments, the eye pose-based geometric transformation identification operation 206 can determine geometric transformation matrices based on the user's eye poses. For example, rotation matrices can be determined based on the current rotational positions of the user's eyes 406a-406b, which could be expressed in the following manner.

$$\{ \begin{matrix}{R}_{el} = R ( {φ}_{elx} , {φ}_{ely} , {φ}_{elz} ) \\ {R}_{er} = R ( {φ}_{erx} , {φ}_{ery} , {φ}_{erz} )\end{matrix}$$

Here, Rₑₗ represents a rotation matrix associated with the user's left eye 406a, and Rₑᵣ represents a rotation matrix associated with the user's right eye 406b. The values φₑₗₓ, φ_{ely}, and φ_{elz} represent angular measures of rotation of the user's left eye 406a about three axes, and the values ₑᵣₓ, φ_{ery}, and φ_{erz} represent angular measures of rotation of the user's right eye 406b about three axes. The rotation matrices may also be expressed as follows.

$$\{ \begin{matrix}{R}_{el} = ( \begin{matrix}{r}_{el 11} & {r}_{el 12} & {r}_{el 13} \\ {r}_{el 21} & {r}_{el 22} & {r}_{el 23} \\ {r}_{el 32} & {r}_{el 32} & {r}_{el 33}\end{matrix} ) \\ {R}_{er} = ( \begin{matrix}{r}_{er 11} & {r}_{er 12} & {r}_{er 13} \\ {r}_{er 21} & {r}_{er 22} & {r}_{er 23} \\ {r}_{er 32} & {r}_{er 32} & {r}_{er 33}\end{matrix} )\end{matrix}$$

Here, rₑₗ₁₁ through rₑₗ₃₃ represent scalar values based on the rotation angles of the user's left eye 406a about three axes, and rₑᵣ₁₁ through rₑᵣ₃₃ represent scalar values based on the rotation angles of the user's right eye 406b about three axes. These scalar values can be calculated in the following manner, where α, β, and γ represent rotations of the associated eye 406a-406b about its x-axis, y-axis, and z-axis, respectively.

$$R = ( \begin{matrix}cos β cos Υ & sin α sin β cos Υ - cos α sin Υ & cos α sin β cos Υ + sin α sin Υ \\ cos β sin Υ & sin α sin β cos Υ + cos α sin Υ & cos α sin β sin Υ - sin α cos Υ \\ - sin β & sin α cos β & cos α cos β\end{matrix} )$$

This represents a standard way to express a 3D rotation matrix.

Translation vectors of the centers of the user's pupils can also be determined based on the current rotational positions of the user's eyes 406a-406b, which could be expressed in the following manner.

$$\{ \begin{matrix}{T}_{el} = T ( {x}_{el} , {y}_{el} , {z}_{el} ) \\ {T}_{er} = T ( {x}_{er} , {y}_{er} , {z}_{er} )\end{matrix}$$

The translation vectors may also be expressed as follows.

$$\{ \begin{matrix}{T}_{el} = ( {t}_{elx} , {t}_{ely} , {t}_{elz} ) \\ {T}_{er} = ( {t}_{erx} , {t}_{ery} , {t}_{erz} )\end{matrix}$$

Here, tₑₗₓ, t_{ely}, and t_{elz} represent translations of the user's left pupil along three axes, and tₑᵣₓ, t_{ery}, and t_{erz} represent translations of the user's right pupil along three axes.

Once the rotation matrices and the translation vectors for the user's eyes 406a-406b are identified, eye pose-based geometric transformation matrices may be defined, such as in the following manner.

$$\{ \begin{matrix}{M}_{el} = [ {R}_{el} \vert {T}_{el} ] \\ {M}_{er} = [ {R}_{er} \vert {T}_{er} ]\end{matrix}$$

The eye pose-based geometric transformation matrices may also be defined as follows.

$$\{ \begin{matrix}{M}_{el} = ( \begin{matrix}{r}_{el 11} & {r}_{el 12} & {r}_{el 13} & {t}_{elx} \\ {r}_{el 11} & {r}_{el 12} & {r}_{el 13} & {t}_{ely} \\ {r}_{el 11} & {r}_{el 12} & {r}_{el 13} & {t}_{elz} \\ 0 & 0 & 0 & 1\end{matrix} ) \\ {M}_{er} = ( \begin{matrix}{r}_{er 11} & {r}_{er 12} & {r}_{er 13} & {t}_{erx} \\ {r}_{er 11} & {r}_{er 12} & {r}_{er 13} & {t}_{ery} \\ {r}_{er 11} & {r}_{er 12} & {r}_{er 13} & {t}_{erz} \\ 0 & 0 & 0 & 1\end{matrix} )\end{matrix}$$

The eye pose-based geometric transformation identification operation 206 can thereby generate geometric transformation matrices as the user changes his or her focus or otherwise changes his or her eye poses over time.

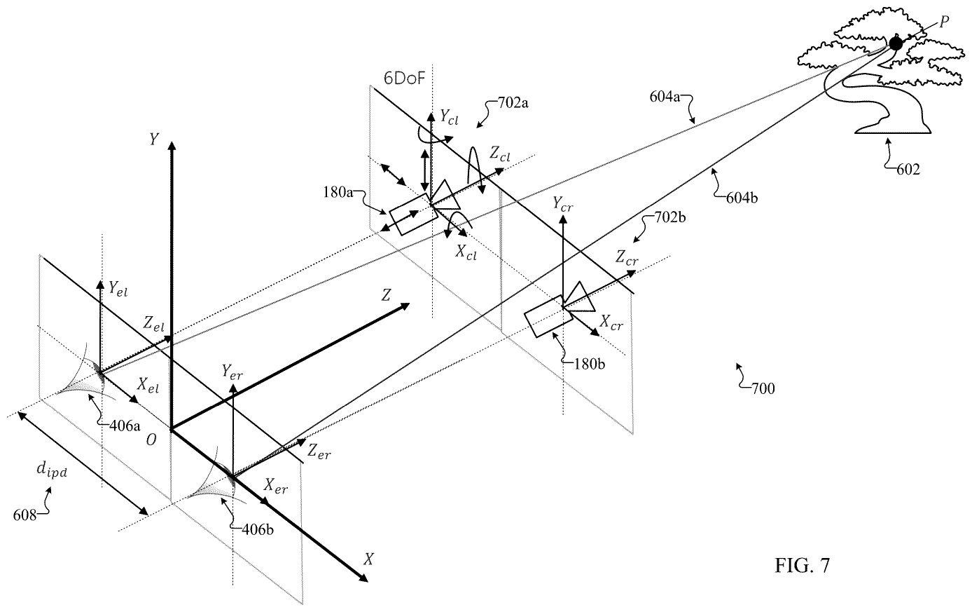

FIG. 7 illustrates an example of camera pose-based geometric transformation 700 in accordance with this disclosure. The camera pose-based geometric transformation 700 may, for example, provide a basis for how the camera pose-based geometric transformation identification operation 208 can be performed. For ease of explanation, the camera pose-based geometric transformation 700 shown in FIG. 7 is described as being performed using the electronic device 101 in the network configuration 100 shown in FIG. 1, which could have the form shown in FIG. 4A. However, the camera pose-based geometric transformation 700 shown in FIG. 7 may be performed using any other suitable device(s) and in any other suitable system(s).

As shown in FIG. 7, the user's eyes 406a-406b are again focusing on the point P of the object 602, and the user's eye poses are associated with the eye gaze vectors 604a-604b and the IPD 608. In FIG. 7, two imaging sensors 180a-180b are also shown, where each imaging sensor 180a-180b can capture image frames of the scene (including the point P of the object 602). The left imaging sensor 180a is associated with a coordinate system 702a, which is defined using an origin O_{cl} and coordinates along three axes X_{cl}, Y_{cl}, and Z_{cl}. The right imaging sensor 180b is associated with a coordinate system 702b, which is defined using an origin O_{cr} and coordinates along three axes X_{cr}, Y_{cr}, and Z_{cr}. In some embodiments, each imaging sensor 180a-180b may have six degrees of freedom (6Dof), indicating that each imaging sensor 180a-180b could move (translate) and turn (rotate) about each of its three axes.

Using this as a basis, in some embodiments, the camera pose-based geometric transformation identification operation 208 can determine geometric transformation matrices based on the camera poses (positions and orientations) of the imaging sensors 180a-180b. For example, rotation matrices can be determined based on the current rotational positions of the imaging sensors 180a-180b, which could be expressed in the following manner.

$$\{ \begin{matrix}{R}_{cl} = R ( {φ}_{clx} , {φ}_{cly} , {φ}_{clz} ) \\ {R}_{cr} = ( {φ}_{crx} , {φ}_{cry} , {φ}_{crz} )\end{matrix}$$

Here, R_{cl} represents a rotation matrix of the left imaging sensor 180a, and R_{cr} represents a rotation matrix of the right imaging sensor 180b. The values φ_{clx}, φ_{cly}, and φ_{clz} represent angular measures of rotation of the imaging sensor 180a about three axes, and the values φ_{crx}, φ_{cry}, and φ_{crz} represent angular measures of rotation of the imaging sensor 180b about three axes. The rotation matrices may also be expressed as follow.

$$\{ \begin{matrix}{R}_{cl} = ( \begin{matrix}{r}_{cl 11} & {r}_{cl 12} & {r}_{cl 13} \\ {r}_{cl 21} & {r}_{cl 22} & {r}_{cl 23} \\ {r}_{cl 32} & {r}_{cl 32} & {r}_{cl 33}\end{matrix} ) \\ {R}_{cr} = ( \begin{matrix}{r}_{cr 11} & {r}_{cr 12} & {r}_{cr 13} \\ {r}_{cr 21} & {r}_{cr 22} & {r}_{cr 23} \\ {r}_{cr 32} & {r}_{cr 32} & {r}_{cr 33}\end{matrix} )\end{matrix}$$

Here, r_{cl11} through r_{cl33} represent scalar values based on the rotation angles of the left imaging sensor 180a, and r_{cr11} through r_{cr33} represent scalar values based on the rotation angles of the right imaging sensor 180b. These scalar values could be determined in the manner discussed above, where α, β, and γ represent rotations of the associated imaging sensor 180a-180b about the electronic device's x-axis, y-axis, and z-axis, respectively.

Translation vectors of the optical centers of the imaging sensors 180a-180b can also be determined based on the current positions of the imaging sensors 180a-180b, which could be expressed in the following manner.

$$\{ \begin{matrix}{T}_{cl} = T ( {x}_{cl} , {y}_{cl} , {z}_{cl} ) \\ {T}_{cr} = T ( {x}_{cr} , {y}_{cr} , {z}_{cr} )\end{matrix}$$

The translation vectors may also be expressed as follows.

$$\{ \begin{matrix}{T}_{cl} = ( {t}_{clx} , {t}_{cly} , {t}_{clz} ) \\ {T}_{cr} = ( {t}_{crx} , {t}_{cry} , {t}_{crz} )\end{matrix}$$

Here, t_{clx}, t_{cly}, and t_{clz} represent translations of the left imaging sensor 180a along three axes, and t_{crx}, t_{cry}, and t_{crz} represents translations of the right imaging sensor 180b along three axes. Note that the rotation and translation values used here may be included in or derivable from extrinsic parameters of the imaging sensors 180a-180b, such as those stored as the camera extrinsic parameters 344.

Once the rotation matrices and the translation vectors for the imaging sensors 180a-180b are identified, camera pose-based geometric transformation matrices may be defined, such as in the following manner.

$$\{ \begin{matrix}{M}_{cl} = [ {R}_{cl} \vert {T}_{cl} ] \\ {M}_{cr} = [ {R}_{cr} \vert {T}_{cr} ]\end{matrix}$$

The camera pose-based geometric transformation matrices may also be defined as follows.

$$\{ \begin{matrix}{M}_{cl} = ( \begin{matrix}{r}_{cl 11} & {r}_{cl 12} & {r}_{cl 13} & {t}_{clx} \\ {r}_{cl 11} & {r}_{cl 12} & {r}_{cl 13} & {t}_{cly} \\ {r}_{cl 11} & {r}_{cl 12} & {r}_{cl 13} & {t}_{clz} \\ 0 & 0 & 0 & 1\end{matrix} ) \\ {M}_{cr} = ( \begin{matrix}{r}_{cr 11} & {r}_{cr 12} & {r}_{cr 13} & {t}_{crx} \\ {r}_{cr 11} & {r}_{cr 12} & {r}_{cr 13} & {t}_{cry} \\ {r}_{cr 11} & {r}_{cr 12} & {r}_{cr 13} & {t}_{crz} \\ 0 & 0 & 0 & 1\end{matrix} )\end{matrix}$$

The camera pose-based geometric transformation identification operation 208 can thereby generate geometric transformation matrices based on the current camera poses of the imaging sensors 180a-180b, which may or may not change over time.

As noted above, the passthrough transformation integration operation 210 can combine various transformations to be applied to image frames, and those transformations can include at least the eye pose-based geometric transformations and the camera pose-based geometric transformations identified by the geometric transformation identification operations 206 and 208. For example, the passthrough transformation integration operation 210 may combine the eye pose-based geometric transformations and the camera pose-based geometric transformations identified by the geometric transformation identification operations 206 and 208 with one or more additional passthrough transformations, such as a camera undistortion transformation matrix, a GDC/CAC transformation matrix, and/or a time warp reprojection, planar reprojection, or depth-based reprojection matrix.

In some cases, a passthrough transformation matrix Mₚₜ associated with one or more additional passthrough transformations could be defined as follows.

Mₚₜ=[Rₚₜ|Tₚₜ]

Here, Rₚₜ represents a passthrough rotation matrix, and Tₚₜ represents a passthrough translation vector. In some embodiments, the passthrough rotation matrix and the passthrough translation vector could be expressed as follows.

$$\{ \begin{matrix}{R}_{pt} = ( \begin{matrix}{r}_{pt 11} & {r}_{pt 12} & {r}_{pt 13} \\ {r}_{pt 21} & {r}_{pt 22} & {r}_{pt 23} \\ {r}_{pt 31} & {r}_{pt 32} & {r}_{pt 33}\end{matrix} ) \\ {T}_{pt} = ( \begin{matrix}{t}_{ptx} & {t}_{pty} & {t}_{ptz}\end{matrix} )\end{matrix}$$

The passthrough rotation matrix and the passthrough translation vector may also be expressed as follows.

$$\{ \begin{matrix}{M}_{ptl} = ( \begin{matrix}{r}_{ptl 11} & {r}_{ptl 12} & {r}_{ptl 13} & {t}_{ptlx} \\ {r}_{ptl 11} & {r}_{ptl 12} & {r}_{ptl 13} & {t}_{ptly} \\ {r}_{ptl 11} & {r}_{ptl 12} & {r}_{ptl 13} & {t}_{ptlz} \\ 0 & 0 & 0 & 1\end{matrix} ) \\ {M}_{ptr} = ( \begin{matrix}{r}_{ptr 11} & {r}_{ptr 12} & {r}_{ptr 13} & {t}_{ptrx} \\ {r}_{ptr 11} & {r}_{ptr 12} & {r}_{ptr 13} & {t}_{ptry} \\ {r}_{ptr 11} & {r}_{ptr 12} & {r}_{ptr 13} & {t}_{ptrz} \\ 0 & 0 & 0 & 1\end{matrix} )\end{matrix}$$

Based on this, the passthrough transformation integration operation 210 could integrate the various transformations as follows.

$$\{ \begin{matrix}{M}_{l} = {M}_{cl} {M}_{ptl} {M}_{el} \\ {M}_{r} = {M}_{cr} {M}_{ptr} {M}_{er}\end{matrix}$$

Here, Mₗ represents a final view transformation for the user's left eye 406a, which could be applied to one or more image frames captured using the left imaging sensor 180a. Also, Mᵣ represents a final view transformation for the user's right eye 406b, which could be applied to one or more image frames captured using the right imaging sensor 180b. These transformations could also be expressed as follows.

$$\{ \begin{matrix}{M}_{l} = ( \begin{matrix}{r}_{cl 11} & {r}_{cl 12} & {r}_{cl 13} & {t}_{clx} \\ {r}_{cl 11} & {r}_{cl 12} & {r}_{cl 13} & {t}_{cly} \\ {r}_{cl 11} & {r}_{cl 12} & {r}_{cl 13} & {t}_{clz} \\ 0 & 0 & 0 & 1\end{matrix} ) ( \begin{matrix}{r}_{ptl 11} & {r}_{ptl 12} & {r}_{ptl 13} & {t}_{ptlx} \\ {r}_{ptl 11} & {r}_{ptl 12} & {r}_{ptl 13} & {t}_{ptly} \\ {r}_{ptl 11} & {r}_{ptl 12} & {r}_{ptl 13} & {t}_{ptlz} \\ 0 & 0 & 0 & 1\end{matrix} ) ( \begin{matrix}{r}_{el 11} & {r}_{el 12} & {r}_{el 13} & {t}_{elx} \\ {r}_{el 11} & {r}_{el 12} & {r}_{el 13} & {t}_{ely} \\ {r}_{el 11} & {r}_{el 12} & {r}_{el 13} & {t}_{elz} \\ 0 & 0 & 0 & 1\end{matrix} ) \\ {M}_{l} = ( \begin{matrix}{r}_{cr 11} & {r}_{cr 12} & {r}_{cr 13} & {t}_{crx} \\ {r}_{cr 11} & {r}_{cr 12} & {r}_{cr 13} & {t}_{cry} \\ {r}_{cr 11} & {r}_{cr 12} & {r}_{cr 13} & {t}_{crz} \\ 0 & 0 & 0 & 1\end{matrix} ) ( \begin{matrix}{r}_{ptl 11} & {r}_{ptl 12} & {r}_{ptl 13} & {t}_{ptlx} \\ {r}_{ptl 11} & {r}_{ptl 12} & {r}_{ptl 13} & {t}_{ptly} \\ {r}_{ptl 11} & {r}_{ptl 12} & {r}_{ptl 13} & {t}_{ptlz} \\ 0 & 0 & 0 & 1\end{matrix} ) ( \begin{matrix}{r}_{er 11} & {r}_{er 12} & {r}_{er 13} & {t}_{erx} \\ {r}_{er 11} & {r}_{er 12} & {r}_{er 13} & {t}_{ery} \\ {r}_{er 11} & {r}_{er 12} & {r}_{er 13} & {t}_{erz} \\ 0 & 0 & 0 & 1\end{matrix} )\end{matrix}$$

The final view rendering and display operation 212 can apply these transformations to image frames from the imaging sensors 180a-180b in order to produce final view frames, which can be rendered for display (with or without additional processing).

Although FIGS. 5 through 7 illustrate examples of eye orientation and IPD tracking 500, eye pose-based geometric transformation 600, and camera pose-based geometric transformation 700, various changes may be made to FIGS. 5 through 7. For example, each of these functions could be implemented in other ways and are not limited to the specific geometries shown in FIGS. 5 through 7.

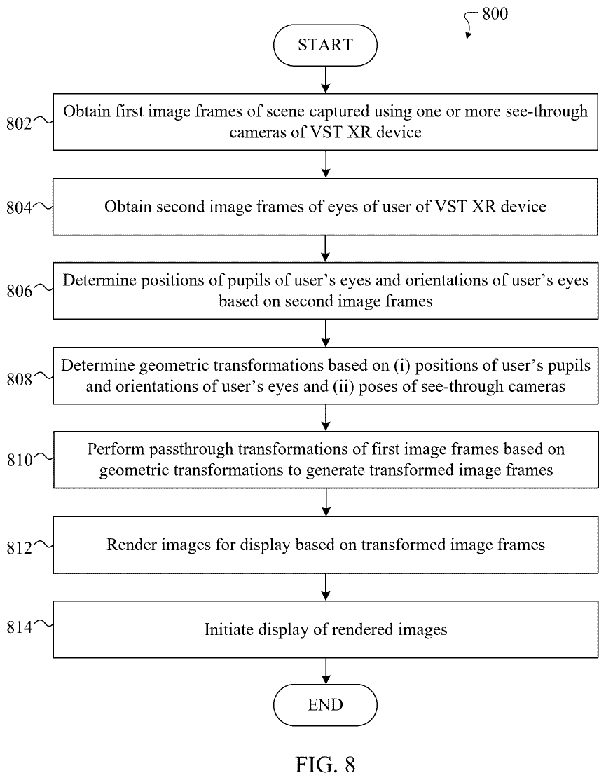

FIG. 8 illustrates an example method 800 for dynamically-adaptive geometric transformations based on eye pose and camera pose changes for VST XR in accordance with this disclosure. For ease of explanation, the method 800 shown in FIG. 8 is described as being performed using the electronic device 101 in the network configuration 100 shown in FIG. 1, which may implement the process 200 shown in FIG. 2 or in the process 300 shown in FIGS. 3A and 3B. However, the method 800 shown in FIG. 8 may be performed using any other suitable device(s) and in any other suitable system(s).

As shown in FIG. 8, first image frames of a scene captured using one or more see-through cameras of a VST XR device are obtained at step 802. This may include, for example, the processor 120 of the electronic device 101 obtaining a sequence or other collection of image frames using one or more imaging sensors 180, 180a-180b of the electronic device 101. Second image frames of eyes of a user of the VST XR device are obtained at step 804. This may include, for example, the processor 120 of the electronic device 101 obtaining sequences of image frames from eye-tracking imaging sensors 404 of the electronic device 101. The second image frames may capture the user's eyes 406a-406b as illuminated by illumination sources 402 of the electronic device 101.

Positions of pupils of the user's eyes and orientations of the user's eyes are determined based on the second image frames at step 806. This may include, for example, the processor 120 of the electronic device 101 performing the eye pose and IPD tracking operation 204 to identify the centers of the pupils of the user's eyes 406a-406b in the second image frames, which could be used to identify the IPD of the user. This may also include the processor 120 of the electronic device 101 performing the eye pose and IPD tracking operation 204 to identify eye gaze vectors representing the orientations of the user's eyes 406a-406b. In some cases, the positions of the user's pupils and/or the orientations of the user's eyes 406a-406b may be determined based on reflections or glints captured in the second image frames.

Geometric transformations are determined based on (i) the positions of the user's pupils and the orientations of the user's eyes and (ii) poses of the see-through cameras at step 808. This may include, for example, the processor 120 of the electronic device 101 performing the eye pose-based geometric transformation identification operation 206 to identify geometric transformations to be applied to image frames captured by left and right imaging sensors 180a-180b based on the positions of the user's pupils and the orientations of the user's eyes 406a-406b. This may also include the processor 120 of the electronic device 101 performing the camera pose-based geometric transformation identification operation 208 to identify geometric transformations to be applied to image frames captured by left and right imaging sensors 180a-180b based on the poses of the imaging sensors 180a-180b.

In some embodiments, the eye pose-based geometric transformation identification operation 206 could determine first geometric transformation matrices based on the positions of the user's pupils and the orientations of the user's eyes 406a-406b. The camera pose-based geometric transformation identification operation 208 could identify second geometric transformation matrices based on the poses of the see-through cameras. The passthrough transformation integration operation 210 could combine the first geometric transformation matrices and the second geometric transformation matrices to generate final geometric transformation matrices for the user's eyes 406a-406b. The first geometric transformation matrices could be generated by determining rotation matrices using the orientations of the user's eyes 406a-406b, determining translation vectors using the positions of the user's pupils, and combining the rotation matrices and the translation vectors to generate the first geometric transformation matrices. In some cases, the poses of the see-through cameras could be expressed relative to the VST XR device or other electronic device 101 and could be based on extrinsic parameters determined during calibration of the device. Also, in some cases, the first geometric transformation matrices may be dynamic and could vary based on movements of the user's eyes 406a-406b, while the second geometric transformation matrices may be static and may not vary based on the movements of the user's eyes 406a-406b.

Passthrough transformations of the first image frames are performed based on the geometric transformations to generate transformed image frames at step 810. This may include, for example, the processor 120 of the electronic device 101 performing the final view rendering and display operation 212 to apply the integrated transformations (including the geometric transformations) to the image frames from the left and right imaging sensors 180a-180b. Images are rendered based on the transformed image frames at step 812, and display of the rendered images can be initiated at step 814. This may include, for example, the processor 120 of the electronic device 101 performing the final view rendering and display operation 212 to render images and present the rendered images to a user of the electronic device 101, such as on one or more display 160.

Although FIG. 8 illustrates one example of a method 800 for dynamically-adaptive geometric transformations based on eye pose and camera pose changes for VST XR, various changes may be made to FIG. 8. For example, while shown as a series of steps, various steps in FIG. 8 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of a video-see through (VST) extended reality (XR) device, first image frames of a scene captured using one or more see-through cameras of the VST XR device;
obtaining, using the at least one processing device, second image frames of eyes of a user of the VST XR device;
determining, using the at least one processing device, positions of pupils of the user's eyes and orientations of the user's eyes based on the second image frames;
determining, using the at least one processing device, geometric transformations based on (i) the positions of the user's pupils and the orientations of the user's eyes and (ii) poses of the see-through cameras;
performing, using the at least one processing device, passthrough transformations of the first image frames based on the geometric transformations to generate transformed image frames; and
rendering, using the at least one processing device, images for display based on the transformed image frames.

2. The method of claim 1, wherein determining the geometric transformations comprises:
determining first geometric transformation matrices based on the positions of the user's pupils and the orientations of the user's eyes;
identifying second geometric transformation matrices based on the poses of the see-through cameras; and
combining the first geometric transformation matrices and the second geometric transformation matrices to generate final geometric transformation matrices for the user's eyes.

3. The method of claim 2, wherein determining the first geometric transformation matrices comprises:
determining rotation matrices using the orientations of the user's eyes;
determining translation vectors using the positions of the user's pupils; and
combining the rotation matrices and the translation vectors to generate the first geometric transformation matrices.

4. The method of claim 2, wherein:
the first geometric transformation matrices are dynamic and vary based on movements of the user's eyes; and
the second geometric transformation matrices are static and do not vary based on the movements of the user's eyes.

5. The method of claim 1, wherein the second image frames capture the user's eyes as illuminated by light sources of the VST XR device.

6. The method of claim 1, wherein the poses of the see-through cameras are expressed relative to the VST XR device and are based on extrinsic parameters determined during calibration of the VST XR device.

7. The method of claim 1, further comprising:
initiating display of the rendered images on one or more display panels of the VST XR device.

8. A video-see through (VST) extended reality (XR) device comprising:
one or more see-through cameras; and
at least one processing device configured to:
obtain first image frames of a scene captured using the one or more see-through cameras;
obtain second image frames of eyes of a user of the VST XR device;
determine positions of pupils of the user's eyes and orientations of the user's eyes based on the second image frames;
determine geometric transformations based on (i) the positions of the user's pupils and the orientations of the user's eyes and (ii) poses of the see-through cameras;
perform passthrough transformations of the first image frames based on the geometric transformations to generate transformed image frames; and
render images for display based on the transformed image frames.

9. The VST XR device of claim 8, wherein, to determine the geometric transformations, the at least one processing device is configured to:
determine first geometric transformation matrices based on the positions of the user's pupils and the orientations of the user's eyes;
identify second geometric transformation matrices based on the poses of the see-through cameras; and
combine the first geometric transformation matrices and the second geometric transformation matrices to generate final geometric transformation matrices for the user's eyes.

10. The VST XR device of claim 9, wherein, to determine the first geometric transformation matrices, the at least one processing device is configured to:
determine rotation matrices using the orientations of the user's eyes;
determine translation vectors using the positions of the user's pupils; and
combine the rotation matrices and the translation vectors to generate the first geometric transformation matrices.

11. The VST XR device of claim 9, wherein:
the first geometric transformation matrices are dynamic and vary based on movements of the user's eyes; and
the second geometric transformation matrices are static and do not vary based on the movements of the user's eyes.

12. The VST XR device of claim 8, wherein the second image frames capture the user's eyes as illuminated by light sources of the VST XR device.

13. The VST XR device of claim 8, wherein the poses of the see-through cameras are expressed relative to the VST XR device and are based on extrinsic parameters determined during calibration of the VST XR device.

14. The VST XR device of claim 8, wherein the at least one processing device is further configured to initiate display of the rendered images on one or more display panels of the VST XR device.

15. A non-transitory machine readable medium containing instructions that when executed cause at least one processor of a video-see through (VST) extended reality (XR) device to:
obtain first image frames of a scene captured using one or more see-through cameras of the VST XR device;
obtain second image frames of eyes of a user of the VST XR device;
determine positions of pupils of the user's eyes and orientations of the user's eyes based on the second image frames;
determine geometric transformations based on (i) the positions of the user's pupils and the orientations of the user's eyes and (ii) poses of the see-through cameras;
perform passthrough transformations of the first image frames based on the geometric transformations to generate transformed image frames; and
render images for display based on the transformed image frames.

16. The non-transitory machine readable medium of claim 15, wherein the instructions that when executed cause the at least one processor to determine the geometric transformations comprise instructions that when executed cause the at least one processor to:
determine first geometric transformation matrices based on the positions of the user's pupils and the orientations of the user's eyes;
identify second geometric transformation matrices based on the poses of the see-through cameras; and
combine the first geometric transformation matrices and the second geometric transformation matrices to generate final geometric transformation matrices for the user's eyes.

17. The non-transitory machine readable medium of claim 16, wherein the instructions that when executed cause the at least one processor to determine the first geometric transformation matrices comprise instructions that when executed cause the at least one processor to:
determine rotation matrices using the orientations of the user's eyes;
determine translation vectors using the positions of the user's pupils; and
combine the rotation matrices and the translation vectors to generate the first geometric transformation matrices.

18. The non-transitory machine readable medium of claim 16, wherein:
the first geometric transformation matrices are dynamic and vary based on movements of the user's eyes; and
the second geometric transformation matrices are static and do not vary based on the movements of the user's eyes.

19. The non-transitory machine readable medium of claim 15, wherein the poses of the see-through cameras are expressed relative to the VST XR device and are based on extrinsic parameters determined during calibration of the VST XR device.

20. The non-transitory machine readable medium of claim 15, wherein the second image frames capture the user's eyes as illuminated by light sources of the VST XR device.
